(19) United States
(12) Patent Application Publication
(10) Pub. No.: US 2003/0111697 A1
(43) Pub. Date: Jun. 19, 2003

(54) Biased bending vertical alignment mode liquid crystal display

(76) Inventor: Seok-Lyul Lee, Taoyuan (TW)

Correspondence Address: GAZDZINSKI & ASSOCIATES, 11440 WEST BERNARDO COURT, SUITE 375, SAN DIEGO, CA, 92127, US

(21) Appl. No.: 10/020,262

(22) Filed: Dec. 13, 2001

(51) Int. Cl. G02F 1/1343

(52) U.S. Cl. 257/393

(57) ABSTRACT

A liquid crystal display comprises a first substrate comprising a first electrode, a second substrate comprising a switching element such as TFT and a second electrode disposed on and connected to the TFT, and a liquid crystal layer comprising a plurality of liquid crystal molecules having a negative dielectric anisotropy and interposed between the substrates. A slit is formed on the second electrode over a center of a gate electrode of the TFT to divide the second electrode into a plurality of fragmented electrode portions, such that the orientations of the liquid crystal molecules in the vicinity above the slit are aligned parallel to the surfaces of the substrates and the orientations of the other liquid crystal molecules are aligned perpendicular to the surfaces of the substrates in dark state, and the orientation of the liquid crystal molecules are aligned parallel to the surfaces of the substrates in white state.

### FIELD OF THE INVENTION

The present invention is in relation to a liquid crystal display (LCD), and more particularly, the present invention is in relation to a biased bending vertical alignment mode liquid crystal display.

### BACKGROUND OF THE INVENTION

The liquid crystal display (or LCD) is made up of two substrates and a liquid crystal layer interposed therebetween. The light is transmitted under the control of the electric field intensity applied to the liquid crystal layer.

The twisted nematic (TN) liquid crystal display, which is currently the most popular LCD, has a transparent matrix substrate and a transparent counter substrate, a pair of transparent electrodes respectively formed on the inner surface of the transparent substrates and opposite to each other so as to drive the liquid crystal layer interposed therebetween, and a pair of polarizing plates which are respectively attached to the outer surfaces of the transparent substrates. In the off state of the LCD, that is, in the state that the electric field is not applied to the transparent electrodes, the orientations of the liquid crystal molecules are aligned perpendicular to the substrates.

Unfortunately, the contrast ratio of the conventional TN LCD in a normally black mode may not be so high because the incident light is not fully blocked in the off state. In order to obviate this problem and increasing the viewing angles of LCD, various LCD modes have been presented. An example of the new LCD mode is known as vertical alignment (VA) mode. As the name suggests, the liquid crystal molecules are normally aligned perpendicular to the inner surface of the substrates, swinging through 90° to lie parallel with substrates in the presence of electric field. This LCD mode produces a display with an ultra-wide viewing angle and high contrast ratio but with the added bonus of higher brightness and a response time of 25 milliseconds. In addition, this LCD mode also consumes less power.

Following the advent of VA mode LCD, a new technique was proposed to align the liquid crystal molecules at a sublevel which uses UV light instead of the usual rubbing. This technique involves the addition of pyramid-shaped protrusions with each of liquid crystal cell, the surface of which each makes up a separate domain, in which the liquid crystal molecules are aligned differently from those in other domains. It produces increased viewing angles, at the expense of a reduction in brightness, by ensuring that each of the multiple domains within a pixel cell channel light at an angle to the substrates, instead of at right angles to it. The result is an all-round increase in viewing angle with no variation in color tone as the viewing angle increases and, requiring no rubbing, a simplified manufacturing process with a reduction in the possibility of liquid crystal contamination. When combined with the VA mode, the resultant display is known as a multi-domain vertical alignment (MVA) mode LCD and produces a viewing angle of 160° in all directions with a high contrast ratio of around 300:1.

However, the pyramid-shaped protrusions which are applied to control the tilt direction of the liquid crystal molecules are the major reasons for the low yield and high cost of the LCD products. There is an inclination to develop an active matrix LCD which has an improved response time, an increased viewing angle, an enhanced yield and a lower cost.

### SUMMARY OF THE INVENTION

The foregoing objectives can be attained by providing a liquid crystal display comprising a first substrate, a second substrate opposite to the first substrate, and a liquid crystal layer comprising liquid crystal molecules having a negative dielectric anisotropy and interposed between the first substrate and the second substrate. The first substrate includes a common electrode and the second substrate includes a switching element such as a thin film transistor (or TFT) including a gate electrode, source/drain electrodes (signal electrodes), a gate insulating layer formed on the gate electrode, a semiconductor layer formed on a portion of the gate insulating layer over the gate electrode, and a passivation film covering the entire surface of the second substrate. The second substrate further comprises a pixel electrode disposed on and connected to the switching element, with a slit formed thereon over the center of the gate electrode so as to divide the pixel electrode into a plurality of fragmented electrode portions.

When there is no electric field applied across the liquid crystal layer, the orientations of the liquid crystal molecules in the liquid crystal layer are aligned perpendicular to the surfaces of the substrates, but the liquid crystal molecules in the vicinity of slits are aligned parallel to the surface of substrate to make a dark state. When there is a sufficient electric field applied across the liquid crystal layer, the orientations of the liquid crystal molecules are aligned parallel to the surfaces of the substrates rapidly to make a white state.

Now the foregoing and other features and advantages of the present invention will be more clearly understood through the following descriptions with reference to the enclosed drawings, wherein:

### BRIEF DESCRIPTION OF THE DRAWINGS

FIG. 1 shows the structure of electrodes and the alignment of the liquid crystal molecules of LCD in the dark state in accordance with the present invention;

FIG. 2 shows the structure of electrodes and the alignment of the liquid crystal molecules of LCD in the white state in accordance with the present invention;

FIG. 3 is a plan view showing the pixel region of LCD according to a preferred embodiment of the present invention;

FIG. 4 shows a cross-sectional view of LCD according to a preferred embodiment of the present invention;

FIG. 5 shows a software simulation result of LCD in dark state; and

FIG. 6 shows a software simulation result of the LCD in white state.

### DETAILED DESCRIPTION OF THE PREFERRED EMBODIMENT

An exemplary embodiment of the present invention will now be described in detail by way of the following discussions with reference to the accompanying drawings. It is to be emphasized that the following descriptions of embodiments and examples of the present invention are only illustrative, and it is not intended to be exhaustive or not to be limited to the precise form disclosed.

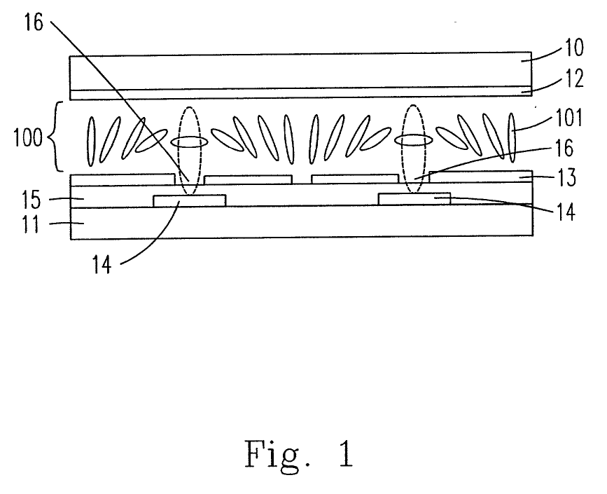

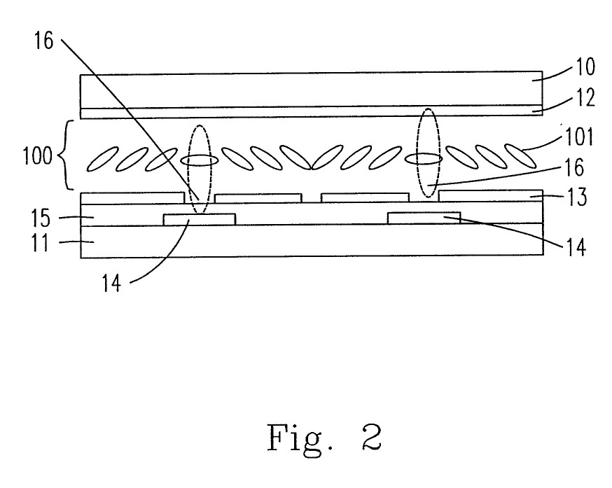

FIG. 1 shows the structure of electrodes and the alignment of the liquid crystal molecules of the LCD in the dark state in accordance with the present invention, and FIG. 2 shows the structure of electrodes and the alignment of the liquid crystal molecules of the LCD in the white state in accordance with the present invention. As indicated in FIG. 1 and FIG. 2, a matrix substrate 10 and a counter substrate 11 made of a transparent insulating material such as glass are spaced apart from each other. Two transparent electrodes 12 and 13 made of a transparent conductive material such as ITO (Indium-Tin-Oxide) are formed respectively on the inner surface of the glass substrates 10 and 11. A liquid crystal layer 100 comprising nematic liquid crystal molecules 101 having a negative dielectric anisotropy is disposed between the matrix substrate 10 and the counter substrate 11. On the outer surface of the substrates 10 and 11, an analyzer and a polarizer are respectively attached to the outer surface of the matrix substrate 10 and the outer surface of the counter substrate 11 (both of which are not shown in the drawings) The polarizer polarize the light beam incident on the liquid crystal layer 100 and the light beam out of the liquid crystal layer 100 respectively. The polarizing directions of the polarizer are perpendicular to each other. A light source (back light) is disposed on the rear of the LCD to act as an optical shutter (not shown). On the other hand, the matrix substrate 10 is further provided with a color filter (not shown)

As shown in FIG. 1 and FIG. 2, the liquid crystal display embodying the present invention is constructed with a matrix substrate 10 and a counter substrate 11, and a liquid crystal layer 100 disposed between the matrix substrate 10 and the counter substrate 11. A common electrode 12 is provided to cover the entire surface of the matrix substrate 10 and a pixel electrode 13 is provided on the inner surface of the counter substrate 11. In accordance with a preferred embodiment of the present invention, the pixel region of LCD is constituted by a matrix consisting of a plurality of scanning electrodes 14 (also referred to as gate electrodes) and a plurality of signal electrodes 15 (also referred to as source/drain electrodes) being arranged in a crossover form. Both the gate electrodes 14 and the signal electrodes 15 are part of a switching element such as a thin film transistor (or TFT), which is formed on the counter substrate 11 and connected to the pixel electrode 13. A plurality of slits 16 are created on the pixel electrode 13 over the center of the gate electrode 14. When the slits 16 are created on the pixel electrodes 13, the pixel electrode 13 is divided into a plurality of fragmented electrode portions. The same signal voltage must be applied to fragmented electrode portions, and an electric connection must be established to interconnect these fragmented electrode portions.

FIG. 1 shows the dark state that the electric field is not applied to the liquid crystal layer 100. The pixel electrode 13 having slits 16 formed over the gate electrodes 14 is provided over the matrix consisting of the gate electrodes 14 and the orthogonal signal electrodes 15. The liquid crystal molecules in the liquid crystal layer 100 are aligned perpendicular to the inner surface of substrates 10 and 11, but the liquid crystal molecules in the vicinity of slit 16 in the liquid crystal layer 100 are aligned parallel to the inner surface of substrates 10 and 11. The polarized light which is generated by the polarizer passes through the portion of the liquid crystal layer 100 where the liquid crystal molecules are aligned parallel with respect to the substrates 10 and 11, so as to make a dark state.

As discussed above, in the absence of electric field, i.e. there is no voltage difference between the electrodes 12 and 13, the liquid crystal molecules 101 are aligned perpendicular to the inner surface of the substrates 10 and 11. However, the liquid crystal molecules in the vicinity of slit 16 on the pixel electrode 13 and over the gate electrodes 14 are aligned parallel to the inner surface of the substrates 10 and 11. Because the voltage difference between the gate electrodes 14 and the common electrode 12 is maintained high enough to keep the oblique liquid crystal molecules 101 parallel to the inner surface of the substrates 10 and 11, the electric field applied to the liquid crystal layer 100 can determine the direction in which the liquid crystal molecules 101 are tilted. The orientation of the liquid crystal molecules 101 is divided into different direction along a plane defined by each pair of fragmented electrode portions over the gate electrode 14.

FIG. 2 shows the white state that the sufficient electric field is applied to the liquid crystal layer 100 by the electrodes 12 and 13, in which the liquid crystal molecules 101 in the liquid crystal layer 100 are twisted spirally by 90° from the counter substrate 11 to the matrix substrate 10, and the direction of the liquid crystal layer 100 varies continuously. The polarized light generated by the polarizer passes through the liquid crystal layer 100 and its polarization is rotated by 90° in accordance with the variation of direction of the liquid crystal layer 100. In this way, the light passes through the analyzer will make a white state. It can be seen from FIG. 2 that if a predetermined voltage difference is applied to the common electrode 12 and the fragmented electrode portions 13, the liquid crystal molecules 101 will easily and rapidly aligned parallel to the inner surface of the substrates 10 and 11, and a white display will appear.

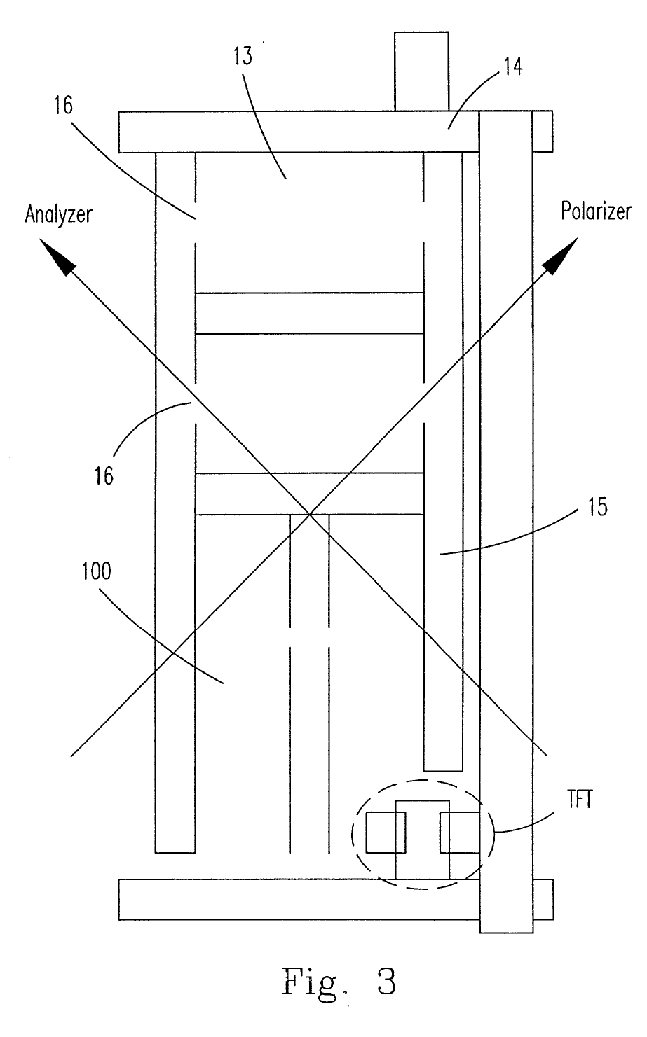

FIG. 3 shows the pixel region of LCD according to a preferred embodiment of the present invention. As shown in FIG. 3, the gate lines 14 are extended horizontally or transversely and crisscross arranged with the signal lines 15 to from a matrix of pixels, each of which is located at the intersection of the gate lines 14 and the signal lines 15. A thin film transistor (or TFT) as a switching element is provided in the vicinity of each pixels. The pixel electrodes 13 are provided in matrix and each connected to the gate lines 14 and the signal lines 15 via the TFT. A plurality of slits 16 are provided on the pixel electrodes 13 to divide the pixel electrodes 13 into a plurality of fragment electrode portions. A spacer (not shown) is provided between the matrix substrate and the counter substrate to produce a gap. A liquid crystal material having a negative dielectric anisotropy is injected into the gap through an injection port (not shown) between the substrates to form a liquid crystal layer 100. Subsequently the injection port is sealed, and a pair of polarizing plates are attached to their respective substrates to finish the production of a LCD.

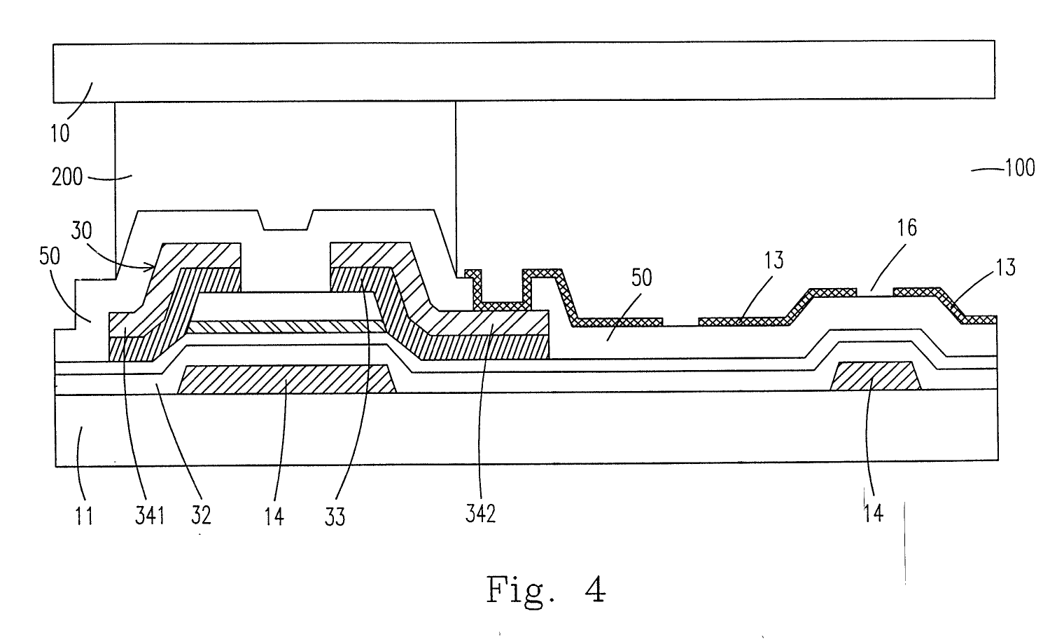

FIG. 4 shows a cross-sectional view of the LCD according to a preferred embodiment of the present invention. As shown in FIG. 4, a spacer 200 formed of a metal or an organic material is formed on the TFT 30 to produce a gap between the matrix substrate 10 and the counter substrate 11. A liquid crystal layer 100 is disposed between the counter substrate 11 having a TFT 30 and a matrix counter having a color filter (not shown). The TFT 30 formed on the counter substrate 11 includes a gate electrode 14, a gate insulating layer 32 formed thereon, an a-Si semiconductor layer 33 formed on a portion of the gate insulating layer 32 over the gate electrode 14, and signal electrodes (source/drain electrodes) 341 and 342 formed on the a-Si semiconductor layer 32. A passivation film 50 covers the enter surface of counter substrate 11. A pixel electrode 13 is formed in the pixel region and electrically coupled to the drain region 342 through a contact hole (not shown) in the passivation film 50. A slit 16 is created on the pixel electrode 13 over the gate electrode 14 to divide the pixel electrodes 13 into a plurality of fragmented electrode portions.

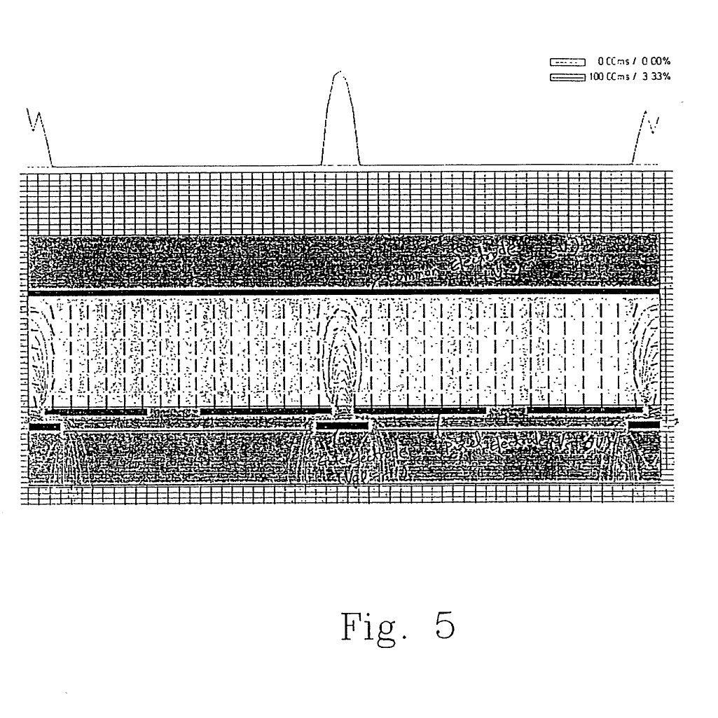

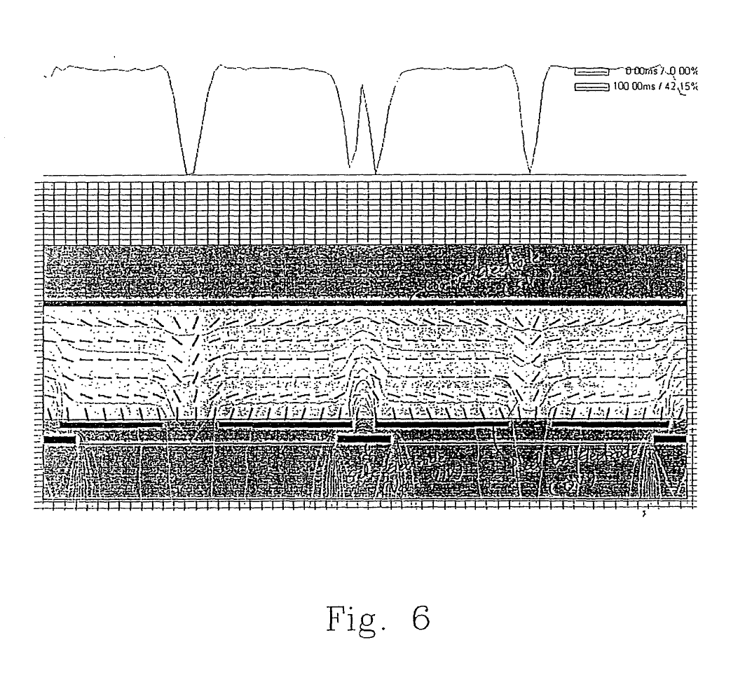

FIG. 5 and FIG. 6 respectively exhibits the software simulation results of the alignment of the liquid crystal molecules of LCD in the dark state and in white state. It can be clearly understood from FIG. 5 that the liquid crystal molecules are aligned perpendicular to the surfaces of substrates to make dark display, except for the liquid crystal molecules in the vicinity of the slits which are lay parallel to the surfaces of substrates. In FIG. 6, it is readily known that the liquid crystal molecules are lay parallel to the surfaces of the substrates to make white display. It should be noted that the software simulation results of alignment of the liquid crystal molecules in FIG. 5 and FIG. 6 respectively has the same profile as those shown in FIG. 1 and FIG. 2, which further proves the practicability of the function of LCD according to the present invention.

As described above, the orientations of the liquid crystal molecules of the LCD according to the present invention is determined by the electric field intensity across the liquid crystal layer. By way of dividing the pixel electrode on the counter substrate into a plurality of fragmented electrode portions so as to create slits over the gate electrode of the thin film transistor, the dark state and the white state of the LCD can be readily and easily achieved by controlling the orientations of the liquid crystal molecules through the electric field across the fragmented electrode portions and the common electrode. In comparison with the prior MVA technology, the present invention substantially removes the protrusions on the matrix substrate, and the liquid crystal alignment method of the liquid crystal display can be accomplished by appropriately applying electric field across the common electrode and fragmented pixel electrodes overlapping the gate electrode to make dark state and white state. Owing to the removal of the protrusions, it is known that the present invention is advantageous in terms of response time, viewing angle, yield and manufacturing cost.

Those of skill in the art will recognize that these and other modifications can be made within the spirit and scope of the present invention as further defined in the appended claims.

What is claim is:

1. A liquid crystal display comprising:
a first substrate comprising a first electrode;
a second substrate comprising a switching element and a second electrode disposed on and connected to said switching element, wherein said switching element at least comprises a gate electrode; and
a liquid crystal layer comprising a plurality of liquid crystal molecules and interposed between said first substrate and said second substrate;
wherein a slit is formed on said second electrode over a center of said gate electrode to divide said second electrode into a plurality of fragmented electrode portions, in order that the orientations of the liquid crystal molecules in the vicinity above said slit are aligned parallel to the surfaces of said first substrate and said second substrate and the orientations of the other liquid crystal molecules are aligned perpendicular to the surfaces of said first substrate and said second substrate in the absence of an electric field across said liquid crystal layer, and the orientation of the liquid crystal molecules are aligned parallel to the surfaces of said first substrate and said second substrate in the presence of a sufficient electric field across said liquid crystal layer.

2. The liquid crystal display of claim 1 wherein said liquid crystal molecules have a negative dielectric anisotropy.

3. The liquid crystal display of claim 1 further comprising a spacer for producing a gap between said first substrate and said second substrate.

4. The liquid crystal display of claim 3 wherein said spacer comprises one of a metal and an organic material.

5. The liquid crystal display of claim 1 further comprising two polarizing plates respectively attached to said first substrate and said second substrate.

6. The liquid crystal display of claim 1 wherein said first electrode and said second electrode are formed of a transparent conductive material.

7. The liquid crystal display of claim 6 wherein said transparent conductive material is an indium-tin-oxide.

8. A liquid crystal display comprising:
a first substrate comprising a common electrode;
a second substrate comprising a plurality of gate lines, a plurality of signal lines, a plurality of pixel electrodes formed in the pixel region defined by said gate lines and said signal lines and separated from each other by a slit located over a center of said gate lines; and
a liquid crystal layer comprising a plurality of liquid crystal molecules and interposed between said first substrate and said second substrate, with a plurality of pixel parts being defined therein in a matrix form;
wherein the orientations of the liquid crystal molecules in the vicinity above said slit are aligned parallel to the surfaces of said first substrate and said second substrate and the orientations of the other liquid crystal molecules are aligned perpendicular to the surfaces of said first substrate and said second substrate in the absence of an electric field across said liquid crystal layer, and the orientation of the liquid crystal molecules are aligned parallel to the surfaces of said first substrate and said second substrate in the presence of a sufficient electric field across said liquid crystal layer.

9. The liquid crystal display of claim 8 wherein said liquid crystal molecules have a negative dielectric anisotropy.

10. The liquid crystal display of claim 8 wherein said second substrate further comprises a gate insulating layer formed on said gate lines.

11. The liquid crystal display of claim 10 wherein said second substrate further comprises a semiconductor layer formed on a portion of said gate insulating layer over said gate lines.

12. The liquid crystal display of claim 8 wherein said liquid crystal molecules have a negative dielectric anisotropy.

13. The liquid crystal display of claim 8 further comprising a spacer for producing a gap between said first substrate and said second substrate.

14. The liquid crystal display of claim 13 wherein said spacer comprises one of a metal and an organic material.

15. The liquid display of claim 8 further comprising two polarizing plates respectively attached to said first substrate and said second substrate.

16. The liquid crystal display of claim 8 wherein said common electrode and said pixel electrodes are formed of a transparent conductive material.

17. The liquid crystal display of claim 16 wherein said transparent conductive material is an indium-tin-oxide.
